(19) United States
(12) Patent Application Publication
(10) Pub. No.: US 2013/0191714 A1
(43) Pub. Date: Jul. 25, 2013

(54) FILL BY EXAMPLE ANIMATION AND VISUALS

(71) Applicants: Chad Rothschiller, Edmonds, WA (US); Eric Cohen, Seattle, WA (US); Karen Cheng, Seattle, WA (US); Josh Leong, Seattle, WA (US); Christopher Benedict, Bellevue, WA (US); Keri Talbot, Seattle, WA (US); Igor Borisov Peev, Seattle, WA (US); Andrew Becker, Duvall, WA (US)

(72) Inventors: Chad Rothschiller, Edmonds, WA (US); Eric Cohen, Seattle, WA (US); Karen Cheng, Seattle, WA (US); Josh Leong, Seattle, WA (US); Christopher Benedict, Bellevue, WA (US); Keri Talbot, Seattle, WA (US); Igor Borisov Peev, Seattle, WA (US); Andrew Becker, Duvall, WA (US)

(73) Assignee: MICROSOFT CORPORATION, Redmond, WA (US)

(21) Appl. No.: 13/358,033

(22) Filed: Jan. 25, 2012

(51) Int. Cl. G06F 17/21; G06F 17/00

(52) U.S. Cl. 715/226; 715/224

(57) ABSTRACT

Animation and visuals are displayed when automatically filling/changing values within a document. A scan animation may be displayed to assist a user in understanding that an action is about to occur using their recent edit(s). A fill animation may be displayed while the suggested values are automatically filled within the document. For example, the suggested values may be displayed according to an uncommitted state (e.g. light grey text) as compared to a committed state (e.g. black text) of related values. The suggested values may be accepted/rejected while they are displayed according to the uncommitted state. When the suggested values are rejected, the suggested values are removed from the display. When the suggested values are accepted, the suggested values are transitioned to the committed state. When a user performs an edit on one or more of the suggested values, a change animation may be displayed.

### BACKGROUND

The same type of data is often entered and stored in many different formats. For example, some dates are in the form CCYYMMDD (19990101), other dates in the format of MM/DD/CCYY (01/01/1999), yet other dates in the format of M/D/YY (1/1/99). To perform analysis on the data, it is converted to the same format. For example, some analysis may specify that phone numbers are to be formatted following the form (206) 555-1212, whereas other analysis may specify that formatting be removed from the phone numbers (i.e. 2065551212). Different methods may be used to transform the data. For example, different transformation functions may be used and/or code may be developed to transform the data.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Animation and visuals are displayed when automatically filling/changing values within a document. For example, before automatically filling suggested values within a document, a scan animation may be displayed to assist a user in understanding that an action is about to occur using their recent edit(s). A fill animation may be displayed while the suggested values are automatically filled within the document. For example, the suggested values may be displayed according to an uncommitted state (e.g. light grey text) as compared to a committed state (e.g. black text) of related values. The suggested values may also appear to be filled into the document one by one. The suggested values may be accepted/rejected while they are displayed according to the uncommitted state. When the suggested values are rejected, the suggested values are removed from the display. When the suggested values are accepted, the suggested values are transitioned to the committed state. For example, a transition animation may be displayed that fades the suggested values from the light grey color representing the uncommitted state to a black color representing the committed state. When a user performs an edit on one or more of the suggested values, a change animation may be displayed such that the user is aware that a range of values is being changed rather than just a single value.

### BRIEF DESCRIPTION OF THE DRAWINGS

FIG. 1 illustrates an exemplary computing environment;

FIG. 2 illustrates an exemplary system for displaying fill by example animation and visuals;

FIG. 3 illustrates displaying animations and visuals during a process of automatically filling values;

FIG. 4 shows an illustrative process for displaying animation and visuals during an automatic fill of values;

FIGS. 5-11 illustrate displaying animations and visuals during an automatic fill process;

FIG. 12 shows an example of a user making edits to the items in a social security number column; and

FIG. 13 illustrates a system architecture used in displaying animations and visuals during an automatic fill.

### DETAILED DESCRIPTION

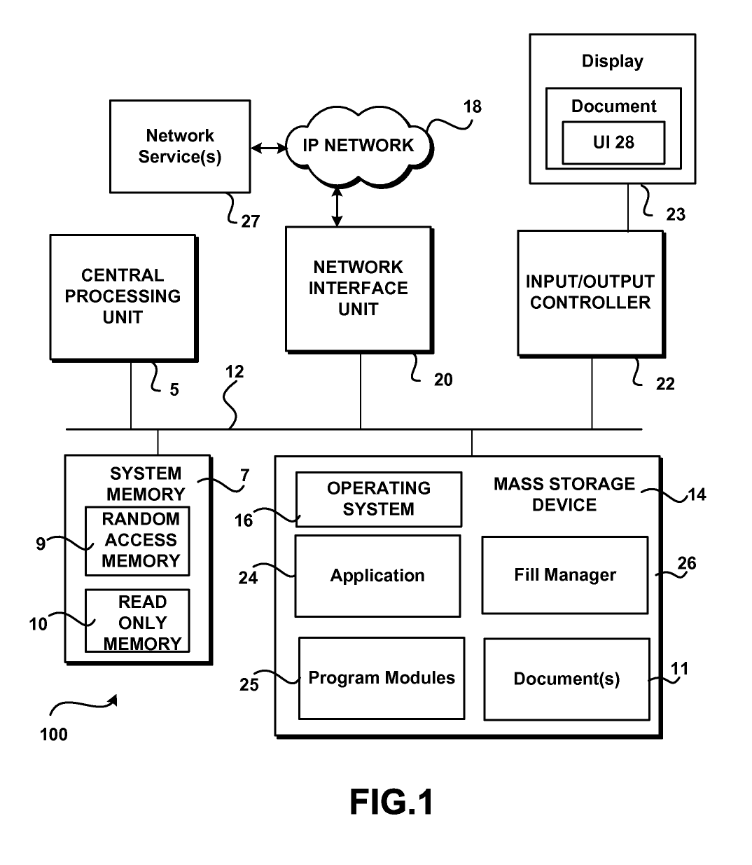

Referring now to the drawings, in which like numerals represent like elements, various embodiment will be described. In particular, FIG. 1 and the corresponding discussion are intended to provide a brief, general description of a suitable computing environment in which embodiments may be implemented.

Generally, program modules include routines, programs, components, data structures, and other types of structures that perform particular tasks or implement particular abstract data types. Other computer system configurations may also be used, including hand-held devices, multiprocessor systems, microprocessor-based or programmable consumer electronics, minicomputers, mainframe computers, and the like. Distributed computing environments may also be used where tasks are performed by remote processing devices that are linked through a communications network. In a distributed computing environment, program modules may be located in both local and remote memory storage devices.

Referring now to FIG. 1, an illustrative computer environment for a computer 100 utilized in the various embodiments will be described. The computer environment shown in FIG. 1 includes computing devices that each may be configured as a server, a desktop or mobile computer, or some other type of computing device and includes a central processing unit 5 (“CPU”), a system memory 7, including a random access memory 9 (“RAM”) and a read-only memory (“ROM”) 10, and a system bus 12 that couples the memory to the central processing unit (“CPU”) 5.

A basic input/output system containing the basic routines that help to transfer information between elements within the computer, such as during startup, is stored in the ROM 10. The computer 100 further includes a mass storage device 14 for storing an operating system 16, application(s) 24 (e.g. productivity application, spreadsheet application, Web Browser, and the like), fill manager 26 which will be described in greater detail below, program modules 25 and document(s) 11 (e.g. spreadsheets).

The mass storage device 14 is connected to the CPU 5 through a mass storage controller (not shown) connected to the bus 12. The mass storage device 14 and its associated computer-readable media provide non-volatile storage for the computer 100. Although the description of computer-readable media contained herein refers to a mass storage device, such as a hard disk or CD-ROM drive, the computer-readable media can be any available media that can be accessed by the computer 100.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, Erasable Programmable Read Only Memory (“EPROM”), Electrically Erasable Programmable Read Only Memory (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer 100.

Computer 100 operates in a networked environment using logical connections to remote computers through a network 18, such as the Internet. The computer 100 may connect to the network 18 through a network interface unit 20 connected to the bus 12. The network connection may be wireless and/or wired. The network interface unit 20 may also be utilized to connect to other types of networks and remote computer systems. For example, computing device 100 may connect to a network service 27. The computer 100 may also include an input/output controller 22 for receiving and processing input from a number of other devices, including a keyboard, mouse, a touch input device, or electronic stylus (not shown in FIG. 1). Similarly, an input/output controller 22 may provide input/output to a display screen 23, a printer, or other type of output device.

A touch input device may utilize any technology that allows single/multi-touch input to be recognized (touching/non-touching). For example, the technologies may include, but are not limited to: heat, finger pressure, high capture rate cameras, infrared light, optic capture, tuned electromagnetic induction, ultrasonic receivers, transducer microphones, laser rangefinders, shadow capture, and the like. According to an embodiment, the touch input device may be configured to detect near-touches (i.e. within some distance of the touch input device but not physically touching the touch input device). The touch input device may also act as a display. The input/output controller 22 may also provide output to one or more display screens 23, a printer, or other type of input/output device.

A camera and/or some other sensing device may be operative to record one or more users and capture motions and/or gestures made by users of a computing device. Sensing device may be further operative to capture spoken words, such as by a microphone and/or capture other inputs from a user such as by a keyboard and/or mouse (not pictured). The sensing device may comprise any motion detection device capable of detecting the movement of a user. For example, a camera may comprise a MICROSOFT KINECT® motion capture device comprising a plurality of cameras and a plurality of microphones.

Embodiments of the invention may be practiced via a system-on-a-chip (SOC) where each or many of the components/processes illustrated in the FIGURES may be integrated onto a single integrated circuit. Such a SOC device may include one or more processing units, graphics units, communications units, system virtualization units and various application functionality all of which are integrated (or “burned”) onto the chip substrate as a single integrated circuit. When operating via a SOC, all/some of the functionality, described herein, with respect to the Unified Communications via application-specific logic integrated with other components of the computing device/system 100 on the single integrated circuit (chip).

As mentioned briefly above, a number of program modules and data files may be stored in the mass storage device 14 and RAM 9 of the computer 100, including an operating system 16 suitable for controlling the operation of a computer, such as the WINDOWS 7®, WINDOWS PHONE 7®, or WINDOWS SERVER® operating system from MICROSOFT CORPORATION of Redmond, Wash. The mass storage device 14 and RAM 9 may also store one or more program modules. In particular, the mass storage device 14 and the RAM 9 may store one or more application programs, such as a spreadsheet application, word processing application and/or other applications. According to an embodiment, the MICROSOFT OFFICE suite of applications is included. The application(s) may be client based and/or web based. For example, a network service 27 may be used, such as: MICROSOFT WINDOWS LIVE, MICROSOFT OFFICE 365 or some other network based service.

Fill manager 26 may be located externally from spreadsheet application 24 as shown or may be a part of an application, such as application 24. Further, all/some of the functionality provided by fill manager 26 may be located internally/externally from an application.

Fill manager 26 is configured to display animation and visuals when automatically filling/changing related values within a document. For example, before automatically filling suggested values within a document, a scan animation may be displayed to assist a user in understanding that an action is about to occur using their recent edit(s). A fill animation may be displayed while the suggested values are automatically filled within the document. For example, the suggested values may be displayed according to an uncommitted state (e.g. light grey text) as compared to a committed state (e.g. black text) of related values. The suggested values may also appear to be filled into the document one by one. The suggested values may be accepted/rejected while they are displayed according to the uncommitted state. When the suggested values are rejected, the suggested values are removed from the display. When the suggested values are accepted, the suggested values are transitioned to the committed state. For example, a transition animation may be displayed that fades the suggested values from the light grey color representing the uncommitted state to a black color representing the committed state. When a user performs an edit on one or more of the suggested values, a change animation may be displayed such that the user is aware that a range of values is being changed rather than just a single value. More details regarding the fill manager are disclosed below.

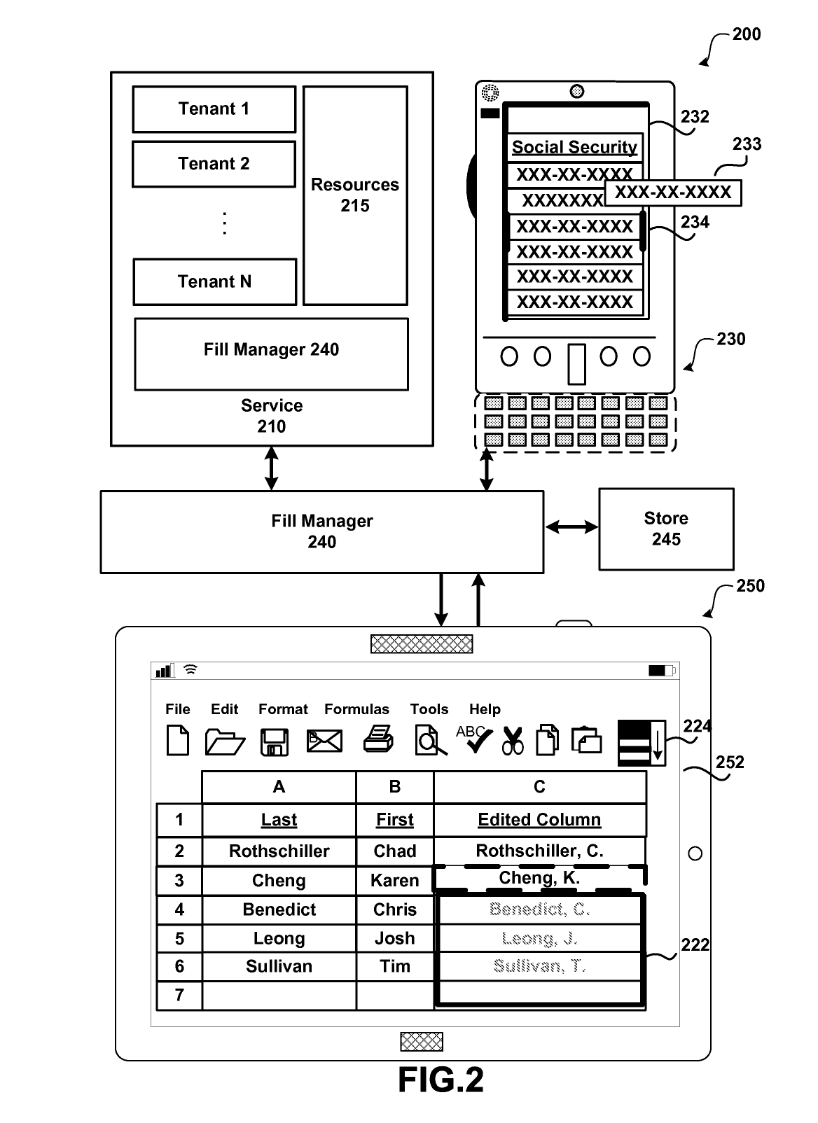

FIG. 2 illustrates an exemplary system for displaying fill by example animation and visuals. As illustrated, system 200 includes service 210, fill manager 240, store 245, touch screen input device/display 250 (e.g. slate) and smart phone 230.

As illustrated, service 210 is a cloud based and/or enterprise based service that may be configured to provide productivity services (e.g. MICROSOFT OFFICE365 or some other cloud based/online service that is used to interact with items (e.g. spreadsheets, documents, charts, and the like). Functionality of one or more of the services/applications provided by service 210 may also be configured as a client based application. For example, a client device may include a spreadsheet application that performs operations relating to selecting items using touch input. Although system 200 shows a productivity service, other services/applications may be configured to automatically fill values within a document and display animation and visuals. As illustrated, service 210 is a multi-tenant service that provides resources 215 and services to any number of tenants (e.g. Tenants 1-N). According to an embodiment, multi-tenant service 210 is a cloud based service that provides resources/services 215 to tenants subscribed to the service and maintains each tenant's data separately and protected from other tenant data.

System 200 as illustrated comprises a touch screen input device/display 250 (e.g. a slate/tablet device) and smart phone 230 that detects when a touch input has been received (e.g. a finger touching or nearly touching the touch screen). Any type of touch screen may be utilized that detects a user's touch input. For example, the touch screen may include one or more layers of capacitive material that detects the touch input. Other sensors may be used in addition to or in place of the capacitive material. For example, Infrared (IR) sensors may be used. According to an embodiment, the touch screen is configured to detect objects that in contact with or above a touchable surface. Although the term “above” is used in this description, it should be understood that the orientation of the touch panel system is irrelevant. The term “above” is intended to be applicable to all such orientations. The touch screen may be configured to determine locations of where touch input is received (e.g. a starting point, intermediate points and an ending point). Actual contact between the touchable surface and the object may be detected by any suitable means, including, for example, by a vibration sensor or microphone coupled to the touch panel. A non-exhaustive list of examples for sensors to detect contact includes pressure-based mechanisms, micro-machined accelerometers, piezoelectric devices, capacitive sensors, resistive sensors, inductive sensors, laser vibrometers, and LED vibrometers.

As illustrated, touch screen input device/display 250 and smart phone 230 shows exemplary displays 252/232 of values that are automatically filled . Documents may be stored on a device (e.g. smart phone 230, slate 250 and/or at some other location (e.g. network store 245). Smart phone 230 shows a display 232 of a table that includes a column of social security numbers. Slate 250 shows a display 252 of a spreadsheet including three columns (A, B and C) and six rows with values. The values, such as cells within a spreadsheet, values within a table, and/or other related values may be displayed by a client based application and/or by a server based application (e.g. enterprise, cloud based).

Fill manager 240 is configured to perform operations relating to interacting with and displaying values/content. Items may be selected/edited in response to touch input and/or other input. Generally, items that are selectable are discrete items such as cells, tables, pictures, words, and other objects that are individually selectable.

As illustrated on smart phone 230, a user is in the process of changing the format of a social security number 233 that is displayed with other social security numbers. The value may be edited using touch input and/or some other input method (e.g. keyboard, mouse, . . . ). In the current example, the user has changed the formatting of the social security number from the format “XXXXXXXXX” to “XXX-XX-XXXX” (where X is any numeral, 0-9). In response to the automatic filling of the values, a change animation is performed that is used to notify the user that a range of values is being updated (instead of just the value the user manually changed). In the current example, the change animation appears to be a set of laser elements (234) that appear to quickly pulse alongside the range where the values are changed.

Slate 250 is configured to display a document, such as spreadsheet document 252, and user interface elements used to interact with a document. As illustrated, spreadsheet 252 shows three columns including a last name column (A), a first name column (B) and an edited column (C). In the current example, a user has made edits to the edited column. In cell C2, the user has entered for that row, row 2, the last name (that is also contained in cell A2), followed by a comma, that is followed by the first initial (that is also contained in cell B2). In cell C3, the user has entered for that row, row 3, the last name (that is also contained in cell A3), followed by a comma, that is followed by the first initial (that is also contained in cell B3).

In response to the edits made to cells C2 and C3, suggested values are determined and a automatically filled into the related range. In this example, the suggested values are used to automatically fill cells C4, C5 and C6 as illustrated by border 222. Generally, a process, such as fill manager 26, detects when the user is editing/modifying data that fits a pattern that can be used to fill an area (e.g. down/up/across) and applied to additional values in the document (e.g. spreadsheet) and automatically fills the range with the results that are obtained from applying a data formatting rule that matches the user's edits. In response to the edits, fill manager 26 uses information that is associated with the edits to obtain a data formatting rule that is applied to other data within the spreadsheet. According to an embodiment, the information includes output examples that result from the edits to the text that is displayed within the edited cells (e.g. cells C2 and C3) and input examples that are associated with the edits. In this case, column A and column B include input examples that are related to the edited column (e.g. cells A2 and B2 is an input example for the output example C2 and cells A3 and B3 is an input example for the output example C3). These input/output examples are determined by fill manager 26 and are supplied to a process that generates a data formatting rule for other similarly formatted cells (e.g. cells C4:C7 (222)). A machine learning heuristic may be used to obtain the set of input/output examples, determines a pattern, generates a data formatting rule, and then fill manager 26 may apply the data formatting rules to an output range to generate newly formatted values (e.g. suggested values). According to an embodiment, an exemplary machine learning heuristic is described in “Automating String Processing in Spreadsheets Using

Input-Output Examples,” by Sumit Gulwani, PoPL'11, Jan. 26-28, 2011, Austin, Tex. Other machine learning heuristics may be utilized. Generally, any heuristic that takes original data as well as data edits as input and produces a data formatting rule that may be applied to other data to result in similarly formatted data may be used. According to an embodiment, the functionality of the machine learning heuristic is included within fill manager 26. The functionality may also be located in other locations.

Fill manager 26 automatically applies the data formatting rule to other cells within the spreadsheet that are similarly formatted. According to an embodiment, the data formatting rule is automatically applied to an output range of cells that fill down the column of the edited column. In the current example, the output range includes cells C4:C7. Box 222 shows that application of the data formatting rules to cells C4:C7 resulted in values being placed within cells C5 and C6. According to an embodiment, the data formatting rule that is applied to the output range is dynamic. In other words, when a value is edited within the output range, the data formatting rule is updated using the additional input/output example(s).

Many types of data formatting rules may be created based on a user's edits. For example, a concatenation of two columns, extracting information from a column (e.g. extracting a top level domain name from an address, extracting an email address) and the like. Generally, a data formatting rule may be calculated based on any editing activity. In some cases, more than two input/output examples may be used to generate accurate results. For example, the machine learning heuristic may only be 50% accurate with two examples and be 95% accurate using three examples.

A data formatting rule may also be obtained based on a selection within a user interface (e.g. icon 224) or some other menu option may be selected. The example edits may be manually selected by a user (e.g. the user selects example cells) and/or the examples may be automatically determined by fill manager 26. For example, fill manager 26 may look at data and determine input/output examples from the data (e.g. a column with the least number of values may be considered as the output column, and the remaining columns may be considered as input columns).

Fill manager 24 is configured to display different animation and visuals in response to automatically filling/changing values within a document. For example, before automatically filling the suggested values within spreadsheet 252, a scan animation may be displayed to assist a user in understanding that an action is about to occur using their recent edit(s). A fill animation may be displayed while the suggested values are automatically filled within the document. For example, the suggested values may be displayed according to an uncommitted state (e.g. light grey text as shown in box 222) as compared to a committed state (e.g. black text as shown in cells C2 and C3) of related values. The suggested values may also appear to be filled into the document one by one. The suggested values may be accepted/rejected while they are displayed according to the uncommitted state. The values may be accepted/rejected using different methods. For example, a user may simply select another area of the display (e.g. touch input/mouse input) and/or select a user interface element (e.g. UI element 224) to perform operations involving the suggested values. When the suggested values are rejected, the suggested values are removed from the display. In the current example, the values in box 222 would be removed from the screen when rejected.

When the suggested values are accepted, the suggested values are transitioned to the committed state. For example, a transition animation may be displayed that fades the suggested values from the light grey color representing the uncommitted state to a black color representing the committed state.

When a user performs an edit on one or more of the suggested values, a change animation (e.g. 234) may be displayed such that the user is aware that a range of values is being changed rather than just a single value. According to an embodiment, elements 234 are shown on each side of a range of value and appear to move along the range of values that are changed.

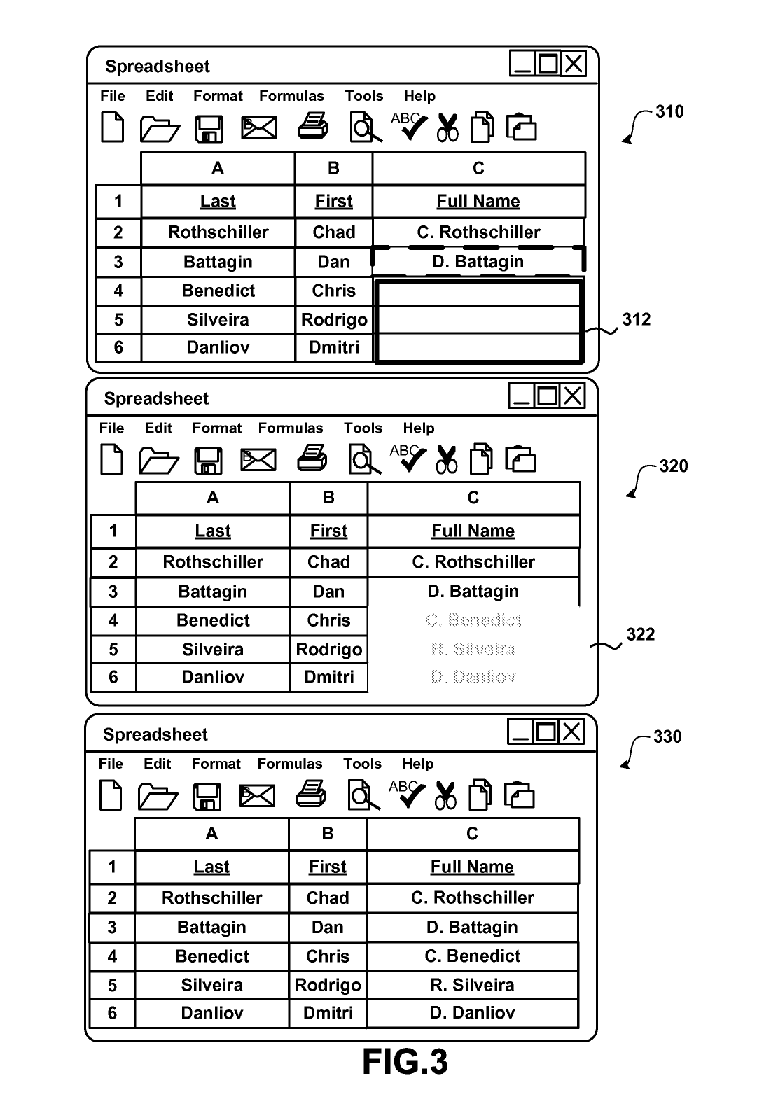

FIG. 3 illustrates displaying animations and visuals during a process of automatically filling values.

As illustrated, a user is making edits to the Full Name column (C) of spreadsheet 310. In the current example, the user has typed a first initial followed by a period and a space that is followed by the last name. The last name is contained in column A of spreadsheet 310 and the first initial is contained in column B of the spreadsheet. In response to the user making the edits to cells C2 and C3, a data formatting rule is generated by a machine learning heuristic that may be applied to other cells within the document.

In the current example, the input/output examples include the text in the C column and the text in the A and B columns for each row that was edited. The input data may be determined by scanning the document to locate data that may be used in application of the data formatting rule to create the desired result. In this case, the data formatting rule creates a rule that obtains the first initial from column B and the last name from column A, as well as inserts a period character and space character after the first initial. The output range 312 indicates the cells to which the data formatting rule is to be applied. In response to determining that suggested values are about to be automatically filled in the document, a scan animation may be displayed to provide an indication that the recently edited values are being used to automatically fill in suggested values. According to an embodiment, the recently edited values used in determining the data formatting rule are temporarily greyed (e.g. flashed with grey) before automatically filling the values.

Referring to spreadsheet 320 it can be seen that the automatic application of the data formatting rule has resulted in cells C4:C6 (322) being filled in with suggested values that includes a first initial that is followed by a period and a space that is followed by a last name. In the current example, the suggested values are initially displayed in an uncommitted state (e.g. light gray or some other different formatting) such that the suggested values are displayed with a sense of “transience” or non-permanence. As the suggested values are automatically filled into the document, the fill may be animated. For example, the suggested values may be displayed as if each value was being filled in one at a time.

Spreadsheet 330 shows the committed state of the suggested values. An animation may be played to transition the display of the suggested values from the uncommitted state to the committed state.

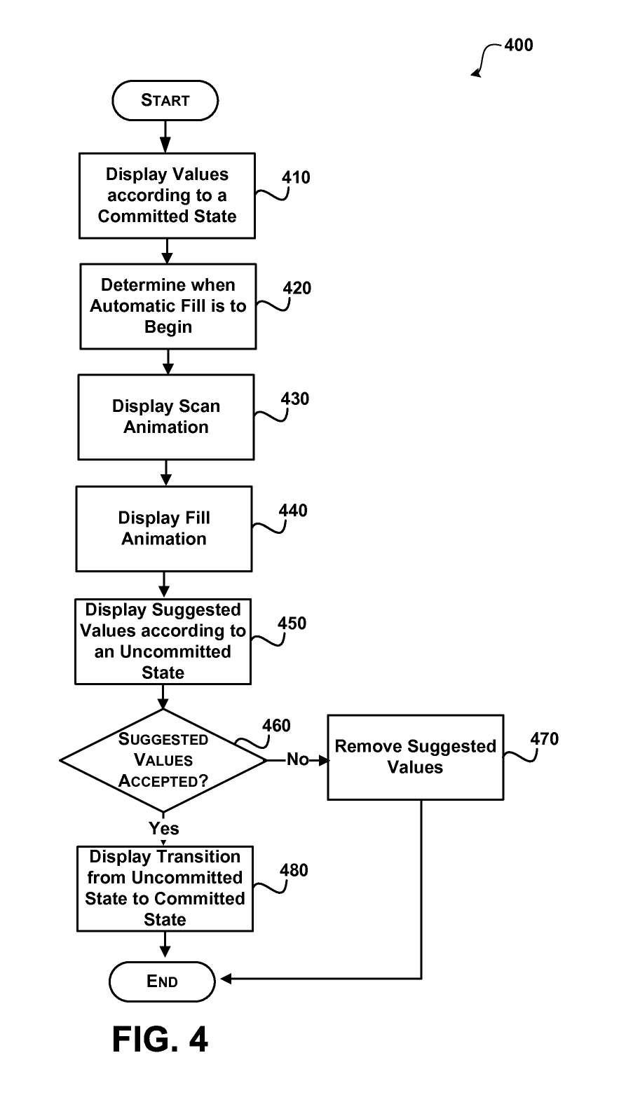

Referring now to FIG. 4, an illustrative process for displaying animation and visuals during an automatic fill of values will be described. When reading the discussion of the routines presented herein, it should be appreciated that the logical operations of various embodiments are implemented (1) as a sequence of computer implemented acts or program modules running on a computing system and/or (2) as interconnected machine logic circuits or circuit modules within the computing system. The implementation is a matter of choice dependent on the performance requirements of the computing system implementing the invention. Accordingly, the logical operations illustrated and making up the embodiments described herein are referred to variously as operations, structural devices, acts or modules. These operations, structural devices, acts and modules may be implemented in software, in firmware, in special purpose digital logic, and any combination thereof While the operations are shown in a particular order, the ordering of the operations may change and be performed in other orderings.

After a start operation, process 400 moves to operation 410, where values are displayed according to a committed state. According to an embodiment, the committed state is the default display state of the document. For example, the document is displayed according to the formatting rules applied/selected by a user and/or default formatting rules for a document.

Moving to decision operation 420, a determination is made as to whether an automatic fill of values is to begin. The automatic fill may occur as a result of different actions. For example, a user may select an option to automatically fill a range with values and/or edits that are made to data within a document may be detected that are used to determine the suggested values used to automatically fill a range.

Flowing to operation 430, a scan animation may be displayed to provide an indication that values (e.g. recently edited/selected) are being used to automatically fill in suggested values. According to an embodiment, the recently edited values used in determining the data formatting rule are temporarily greyed (e.g. flashed with grey) before automatically filling the values. Other animations may be displayed to indicate a start and/or use of an automatic fill process.

Transitioning to operation 440, a fill animation may be displayed during a time the values are being automatically filled in the document. Instead of the automatically filled values appearing to be placed into the document all at one time, the automatically filled values may appear to be inserted at a slower rate (e.g. one at a time, one line at a time, one character at a time . . . ).

Moving to operation 450, the suggested values may be displayed according to an uncommitted state (e.g. light grey text) as compared to a committed state (e.g. black text) of related values. Displaying the suggested values using a different color/formatting is directed at indicating a the sense of “transience” or non-permanence. The suggested values may also be displayed using one or more effects. For example, the suggested values may be displayed using a glow/drop shadow effect that is directed at indicating that the suggested values are not yet committed/entered into the document, but instead are floating above the document. According to an embodiment, worksheet gridlines are not shown while the suggested values are in the uncommitted state.

Flowing to decision operation 460, a determination is made as to whether the suggested values are accepted/rejected. The values may be accepted/rejected using different methods. For example, a user may select the “ESC” key to reject the values and select the “ENTER” key to accept the values. A user may also simply select another area of the display (e.g. touch input/mouse input) and/or select a user interface element to perform operations involving the suggested values. When the suggested values are rejected, the process flows to operation 470. When the suggested values are accepted, the process flows to operation 480.

At operation 470, the suggested values are removed from the display.

At operation 480, the suggested values are transitioned from the uncommitted state to the committed state. For example, a transition animation may be displayed that fades the suggested values from the light grey color representing the uncommitted state to a black color representing the committed state. The gridlines may also be drawn within a grid of a spreadsheet and any effects may be removed.

The process then flows to an end block and returns to processing other actions.

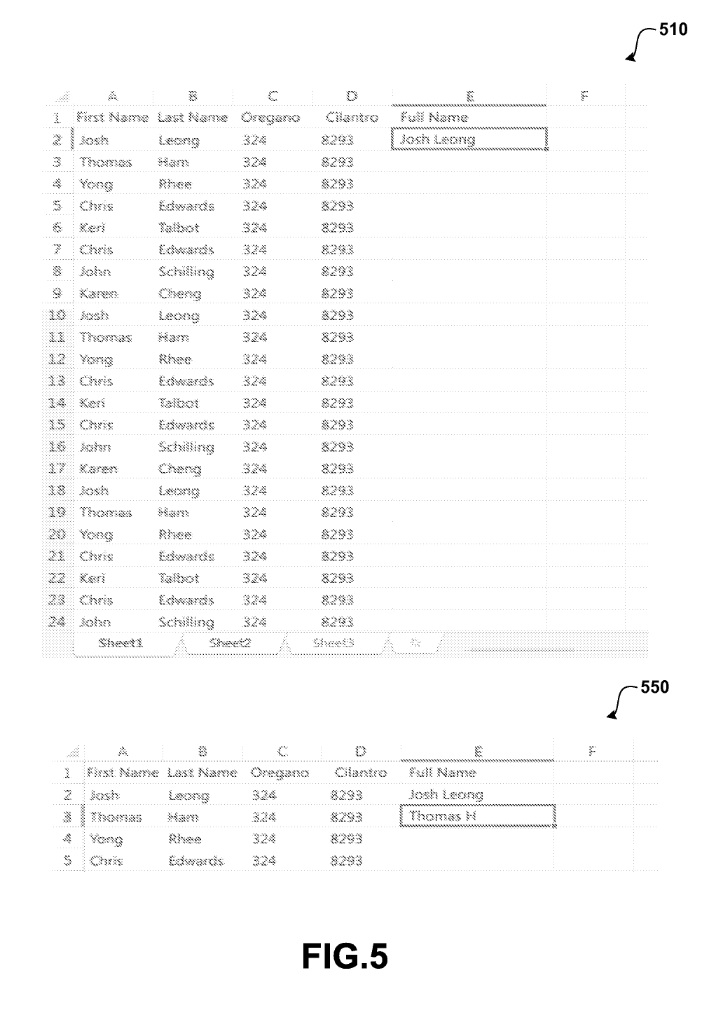

FIGS. 5-11 illustrate displaying animations and visuals during an automatic fill process.

FIG. 5 shows a user entering values into a column of a spreadsheet.

The displayed spreadsheet includes a First Name column, a Last Name column, an Oregano column, a Cilantro column and a Full Name column.

Display 510 shows a user entering a name “Josh Leong” into cell E2 of the Full Name column.

Display 550 shows a user entering a name “Thomas Ham” into cell E2 of the Full Name column.

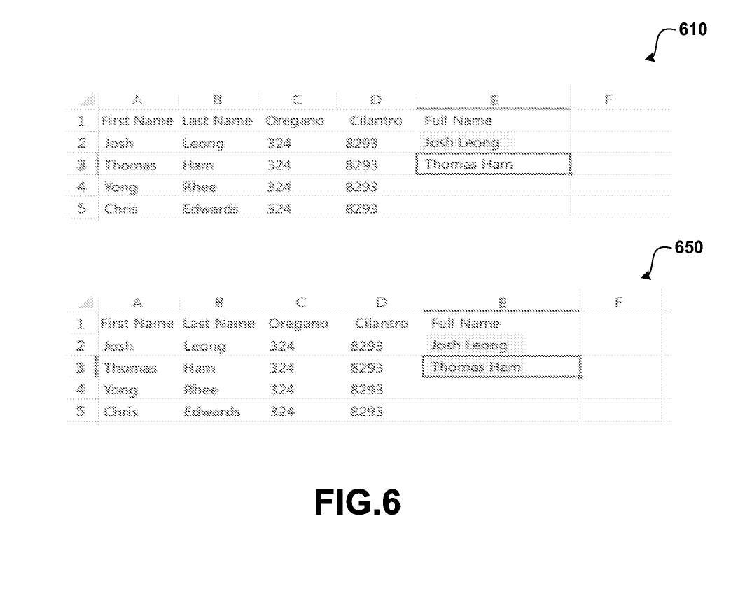

FIG. 6 shows an example scan animation that begins an automatic fill process.

Display 610 shows cell E2 being displayed in a grey color.

Display 650 shows a cell E3 being displayed in a grey color shortly after displaying cell E2 in a grey color to indicate a scanning action.

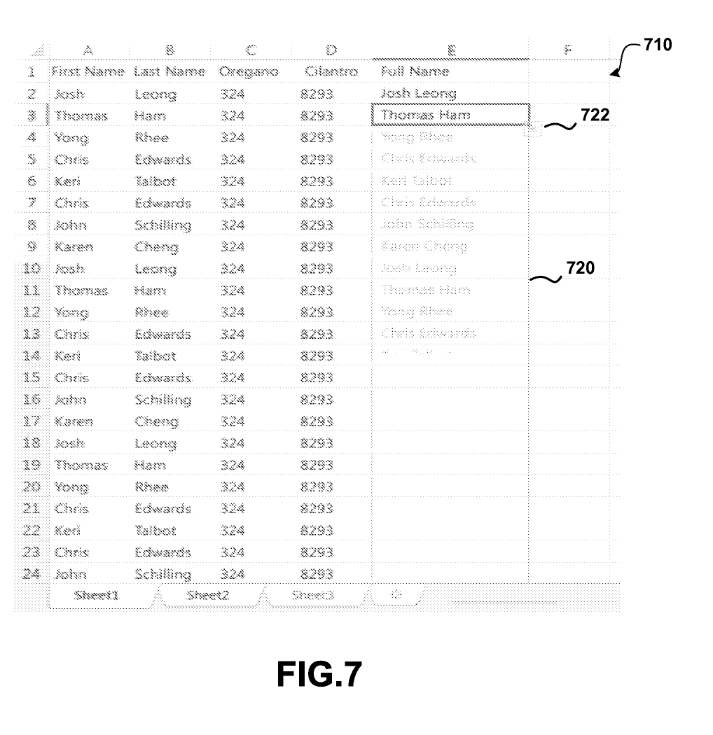

FIG. 7 shows an example fill animation that shows suggested values in an uncommitted state.

Display 710 shows suggested values 720 being automatically filled into the range from E4-E24. According to an embodiment, the suggested values appear to be entered into the spreadsheet one at a time from top to bottom. The suggested values are also displayed in an uncommitted state. In the current example, the suggested values that were automatically filled in are displayed in a lighter color and the grid lines of the cells in the auto fill range may be removed/displayed differently. The border around the automatically filled values may/may not be displayed. According to an embodiment, user interface element 722 is displayed that may be used by a user to reject the suggested values. According to another embodiment, a user interface element may be displayed that includes other options, such as: an undo option, a stop option, a review option, an ignore all option, a save option, and the like.

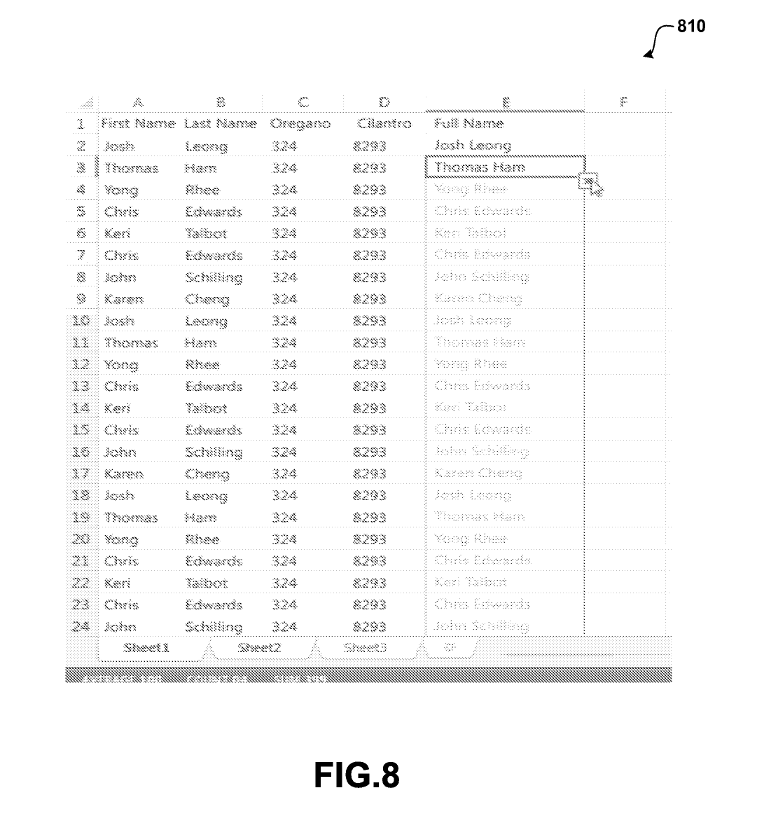

FIG. 8 shows an example fill animation that shows suggested values in an uncommitted state.

Display 810 shows the suggested values filled into the range from E4-E24.

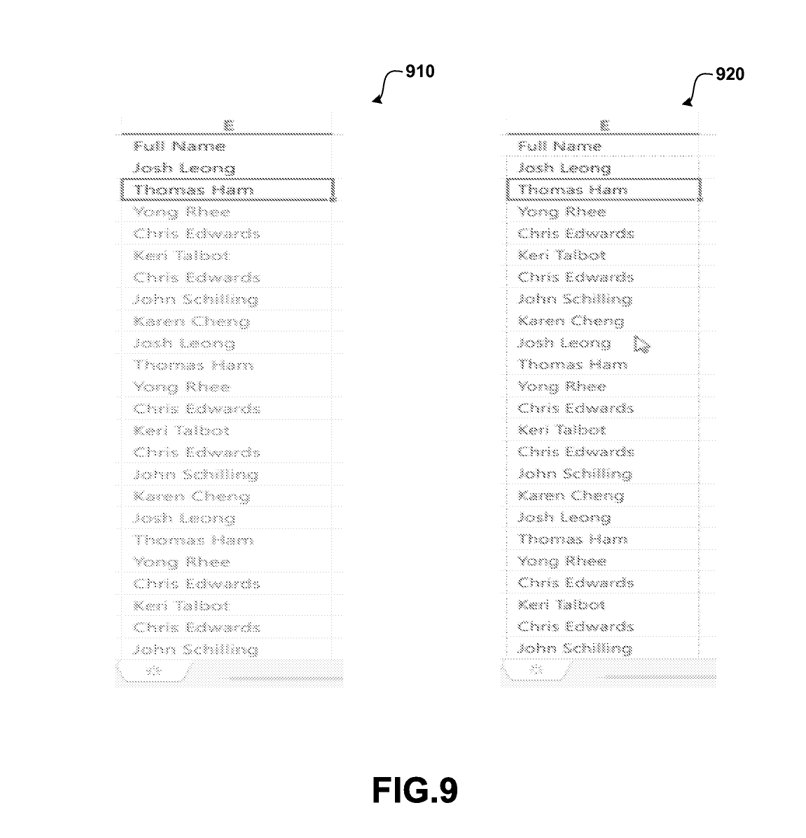

FIG. 9 shows an example transition animation that shows suggested values in an uncommitted state transitioning to a committed state.

Display 910 shows the suggested values displayed in the uncommitted state.

Display 920 shows the suggested values displayed in the committed state. The suggested values fade from grey to black, and the drop shadow disappears, giving the effect of the values settling into and being committed to the worksheet.

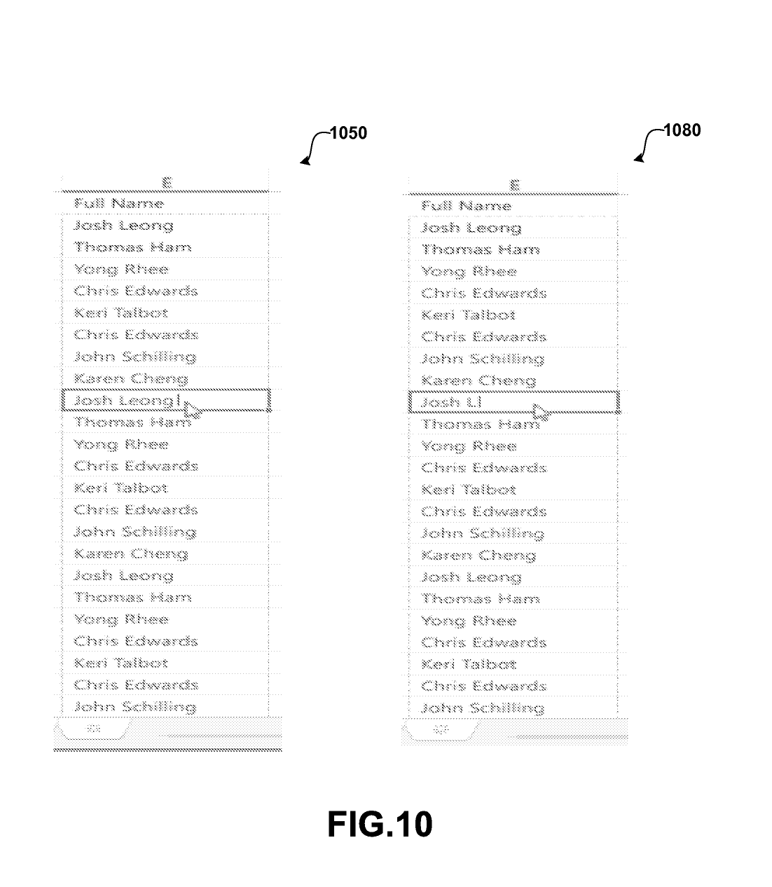

FIG. 10 shows an example that shows a user editing a value within a range of related values that results in an automatic change to each of the related values within the range.

Display 1050 shows the selection of the name “Josh Leong” for editing.

Display 1080 shows the user changing “Josh Leong” to “Josh L”.

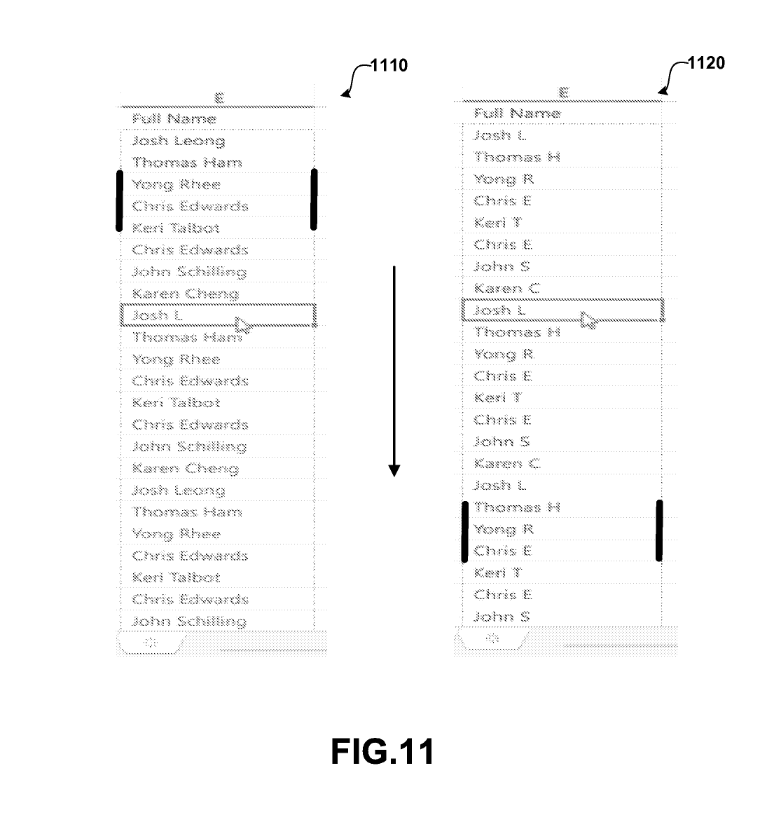

FIG. 11 shows the change animation being displayed as a result of the other related values within the range being automatically changed.

Display 1110 shows the change animation in a first state and display 1120 shows the change animation in a second state.

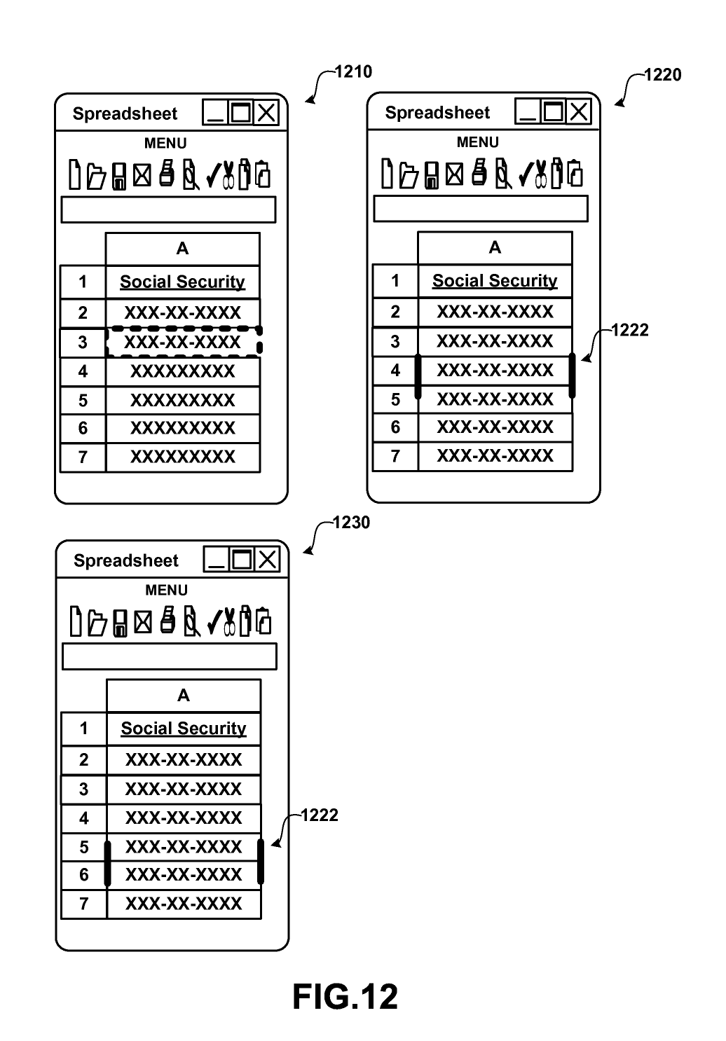

FIG. 12 shows an example of a user making edits to the items in a social security number column. Display 1210 shows that the user has changed the formatting of the social security number from the format “XXXXXXXXX” to “XXX-XX-XXXX” (where X is any numeral, 0-9). In other examples, the characters may non-numerical characters. According to an embodiment, after a user has made two or more edits the input/output examples are used by the fill manager to generate the data formatting rule that is applied to the other data in the column.

Application of the data formatting rule to cells A4:A7 result in the spreadsheet as illustrated by display 1220. According to an embodiment, cells that already contain data are not changed automatically. Instead, a user may be requested to affirmatively accept the proposed changes before they are made to the cells containing data. The cells may be also be changed automatically and the user provided with an opportunity to undo the changes.

In response to the application of the data formatting rule that results in values being automatically changed a change animation is performed that is used to notify the user that a range of values is being updated (instead of just the value the user manually changed). In the current example, the change animation appears to be a set of laser elements (1222) that appear to quickly pulse alongside the range where the values are changed. The elements 1222 are displayed both on the left and right vertical borders of the range. Display 1220 and display 1230 show the elements at different locations within the range.

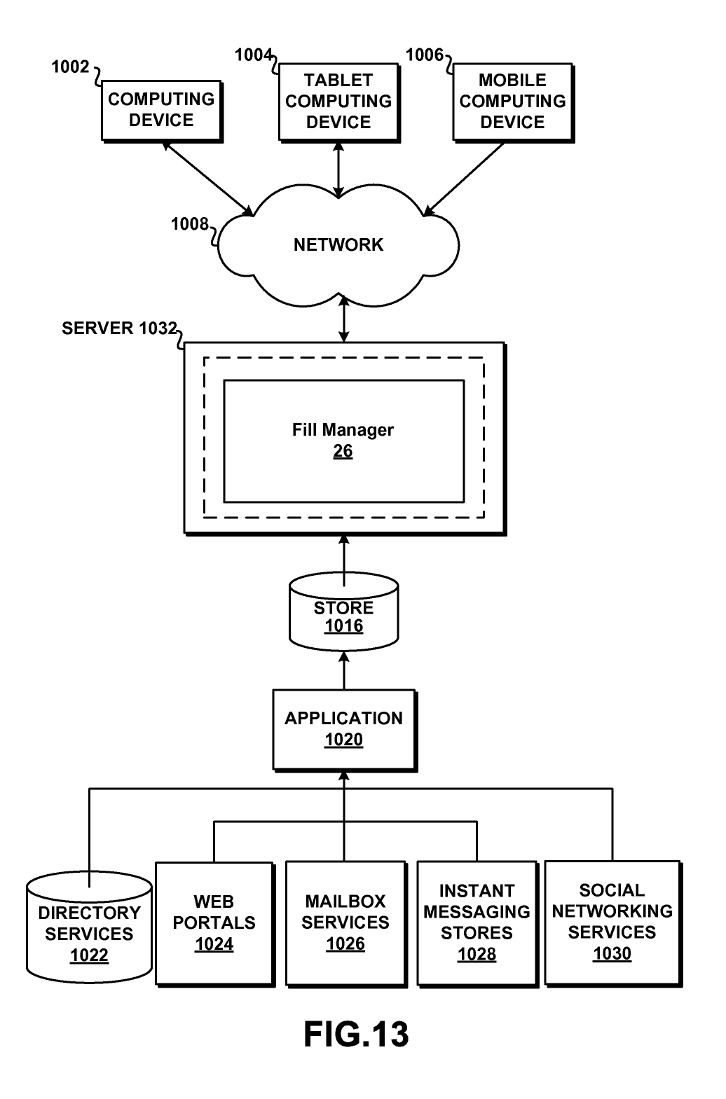

FIG. 13 illustrates a system architecture used in displaying animations and visuals during an automatic fill, as described herein. Content used and displayed by the application (e.g. application 1020) and the fill manager 26 may be stored at different locations. For example, application 1020 may use/store data using directory services 1022, web portals 1024, mailbox services 1026, instant messaging stores 1028 and social networking sites 1030. The application 1020 may use any of these types of systems or the like. A server 1032 may be used to access sources and to prepare and display electronic items. For example, server 1032 may access spreadsheet cells, objects, charts, and the like for application 1020 to display at a client (e.g. a browser or some other window). As one example, server 1032 may be a web server configured to provide spreadsheet services to one or more users. Server 1032 may use the web to interact with clients through a network 1008. Server 1032 may also comprise an application program (e.g. a spreadsheet application). Examples of clients that may interact with server 1032 and a spreadsheet application include computing device 1002, which may include any general purpose personal computer, a tablet computing device 1004 and/or mobile computing device 1006 which may include smart phones. Any of these devices may obtain content from the store 1016.

The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A method for displaying suggested values that are automatically filled, comprising:
displaying values within the document according to a committed state;
determining when suggested values are to be automatically filled in within a document that are determined using the values displayed according to the committed state;
displaying the suggested values according to an uncommitted state that is different from the committed state when the suggested values are automatically filled in within the document;
determining when the suggested values are accepted and when the suggested values are rejected;
displaying a transition of the suggested values from the uncommitted state to an committed state when the suggested values are accepted such that after the transition, the suggested values are displayed according to the committed state; and
removing the suggested values from within the document when the suggested values are rejected.

2. The method of claim 1, further comprising displaying a scan animation over the displayed values within the document shortly before displaying the suggested values according to the uncommitted state.

3. The method of claim 1, further comprising displaying a fill animation during a time the suggested values are automatically filled in within the document that appears to fill each of the suggested values one at a time within the document.

4. The method of claim 1, further comprising displaying a change animation that appears to move along a range of the suggested values in response to automatically filling in the suggested values.

5. The method of claim 1, further comprising displaying a graphical user interface element near the display of the suggested values that when selected provides at least one of: rejecting the suggested values and options for performing operations relating to the suggested values.

6. The method of claim 1, wherein the document is a spreadsheet document and wherein the suggested values are filled in to different cells within a same column of the spreadsheet.

7. The method of claim 1, further comprising displaying a scan animation over the displayed values within the document before displaying a fill animation during a time the suggested values are automatically filled in within the document that appears to fill each of the suggested values one at a time within the document.

8. The method of claim 1, further comprising displaying a glow/drop shadow effect that appears to present the suggested values in an uncommitted state before the suggested values are accepted.

9. The method of claim 1, wherein displaying the transition of the suggested values from the uncommitted state to the committed state when the suggested values are accepted comprises fading a color of the suggested values from an uncommitted color to a color of the displayed values that are committed.

10. A computer-readable medium storing computer-executable instructions for displaying suggested values that are automatically filled, comprising:
determining when suggested values are to be automatically filled in within a document;
displaying the suggested values according to an uncommitted state when the suggested values are automatically filled in within the document;
determining when the suggested values are accepted and when the suggested values are rejected;
displaying a transition of the suggested values from the uncommitted state to an committed state when the suggested values are accepted such that after the transition, the suggested values are displayed according to the committed state; and
removing the suggested values from within the document when the suggested values are rejected.

11. The computer-readable medium of claim 10, further comprising displaying a scan animation over the displayed values within the document before displaying the suggested values according to the uncommitted state.

12. The computer-readable medium of claim 10, further comprising displaying a fill animation during a time the suggested values are automatically filled in within the document that appears to fill each of the suggested values one at a time within the document.

13. The computer-readable medium of claim 10, further comprising displaying a change animation that appears to move along a range of the suggested values in response to automatically filling in the suggested values.

14. The computer-readable medium of claim 10, further comprising displaying a graphical user interface element near the display of the suggested values that when selected provides at least one of: rejecting the suggested values and options for performing operations relating to the suggested values.

15. The computer-readable medium of claim 10, wherein the document is a spreadsheet document and wherein the suggested values are filled in to different cells within a same column of the spreadsheet.

16. The computer-readable medium of claim 10, further comprising displaying a glow/drop shadow effect that appears to present the suggested values in an uncommitted state before the suggested values are accepted.

17. A system for displaying suggested values that are automatically filled, comprising:
a network connection that is configured to connect to a network;
a processor, memory, and a computer-readable storage medium;
an operating environment stored on the computer-readable storage medium and executing on the processor;
a display;
a spreadsheet application;
a spreadsheet; wherein the spreadsheet comprises items that are arranged in rows and columns; and
a fill manager operating in conjunction with the spreadsheet application that is configured to perform actions comprising:
displaying values within the spreadsheet;
determining when suggested values are to be automatically filled in within the spreadsheet;
displaying the suggested values according to an uncommitted state that is different from a committed state when the suggested values are automatically filled in within the spreadsheet;
determining when the suggested values are accepted and when the suggested values are rejected;
displaying a transition of the suggested values from the uncommitted state to the committed state when the suggested values are accepted such that after the transition, the suggested values are displayed according to the committed state; and
removing the suggested values from within the document when the suggested values are rejected.

18. The system of claim 17, further comprising displaying a scan animation over the displayed values within the spreadsheet before displaying the suggested values according to the uncommitted state; and displaying a fill animation during a time the suggested values are automatically filled in within the spreadsheet that appears to fill each of the suggested values one at a time within the spreadsheet.

19. The system of claim 17, further comprising displaying a change animation that appears to move along a range of the suggested values in response to automatically filling in the suggested values.

20. The system of claim 17, further comprising displaying a glow/drop shadow effect that appears to present the suggested values in an uncommitted state before the suggested values are accepted.
